(19) United States
(12) Patent Application Publication
(10) Pub. No.: US 2019/0184239 A1
(43) Pub. Date: Jun. 20, 2019

(54) GOLF BALL MATERIAL, GOLF BALL, AND METHOD OF PRODUCING GOLF BALL MATERIAL

(71) Applicant: Bridgestone Sports Co., Ltd., Tokyo (JP)

(72) Inventor: Atsushi NANBA, Chichibushi (JP)

(73) Assignee: Bridgestone Sports Co., Ltd., Tokyo (JP)

(21) Appl. No.: 16/154,916

(22) Filed: Oct. 9, 2018

(30) Foreign Application Priority Data
Dec. 14, 2017 (JP) 2017-239477

(51) Int. Cl. A63B 37/00; C08L 33/02; C08L 23/08; C08J 3/00; C08J 3/20

(52) U.S. Cl. CPC A63B 37/0094; A63B 37/0004; C08L 33/02; A63B 2102/32; C08J 3/005; C08J 3/203; C08L 23/0876

(57) ABSTRACT

A golf ball material which includes (A) a resin mixture containing as the base resin an acid copolymer in which from 90 to 100 mol % of the acid groups are neutralized with metal ions, and (B) an oxazoline group-containing polymer has a low hardness and a soft feel, and moreover possesses a high rebound resilience. This golf ball material is particularly useful when formed as the intermediate layer in a golf ball having a core, an intermediate layer and an outermost layer with numerous dimples formed on the surface thereof.

### CROSS-REFERENCE TO RELATED APPLICATION

This non-provisional application claims priority under 35 U.S.C. § 119(a) on Patent Application No. 2017-239477 filed in Japan on Dec. 14, 2017, the entire contents of which are hereby incorporated by reference.

### TECHNICAL FIELD

This invention relates to a golf ball material having a high rebound resilience and a soft feel, a golf ball in which a molding of the golf ball material serves as a ball component, and a method of producing the golf ball material.

### BACKGROUND ART

Cover materials commonly used in golf balls are exemplified by materials composed primarily of ionomer resins, and materials in which carboxyl groups on a resin are highly neutralized with metal ions, such as materials made of an ethylene-acid copolymer or a metal salt thereof as the base resin, a fatty acid or fatty acid metal salt that is used together with the base resin, and also a metal ion compound that is added. Stearic acid, oleic acid and metal salts thereof are often used as the fatty acid and metal salt thereof. These golf ball materials are disclosed in, for example, JP-A 2002-514112, JP-A 2004-524418, JP-A 2002-177414 and JP-A 2002-219195.

In addition, JP-A 2016-83368 describes a golf ball material obtained by adding a polyester or an alkyl acrylate to an ethylene-acid copolymer or a metal salt thereof that is highly neutralized with metal ions. However, although alkyl acrylates do have an affinity to ionomers, to the extent that they lack chemical bonds with ionomers, their ability to anchor to the base resin sometimes worsens or a loss of resilience occurs.

Methods for adding, other than polyesters, a styrene-based elastomer such as SEBC or SEBS to an ethylene-acid copolymer or metal salt thereof that is highly neutralized with metal ions have also been described in the prior art. However, such styrene-based elastomers similarly lack chemical bonds with ionomers, and so the same drawback as mentioned above remains.

JP-A H05-68724 describes the inclusion of an oxazoline group-containing thermoplastic resin in an ionomer resin-based cover material. This patent publication mentions that when an oxazoline group-containing thermoplastic resin is mixed into an ionomer resin under applied heat, the oxazoline groups in the thermoplastic resin react with carboxyl groups on the ionomer resin, causing the oxazoline group-containing thermoplastic resin to graft onto the surface of the ionomer resin, thus forming a compatible mixed system, or “polymer alloy,” of the oxazoline group-containing thermoplastic resin microdispersed within the ionomer resin. Synergistic improvements in the physical properties of this polymer alloy enable the toughness of the ionomer resin to be further improved, as a result of which the golf ball has an increased durability.

However, although the golf balls of the foregoing art possess an excellent durability, they have a high rebound resilience and, moreover, can hardly be regarded as having a soft feel.

### SUMMARY OF THE INVENTION

It is therefore an object of the present invention to provide a golf ball material having a high rebound resilience and a soft feel, a golf ball in which a molding of the golf ball material serves as a ball component, and a method of producing the golf ball material.

As a result of extensive investigations, we have discovered that a resin material which includes (A) a resin mixture containing as a base resin an acid copolymer in which from 90 to 100 mol % of the acid groups are neutralized with metal ions, and (B) an oxazoline group-containing polymer, in spite of having a low hardness and a soft feel, possesses an expectedly high rebound resilience, making it ideal as a golf ball material.

Accordingly, in one aspect, the invention provides a golf ball material which includes (A) a resin mixture containing as the base resin an acid copolymer in which from 90 to 100 mol % of the acid groups are neutralized with metal ions, and (B) an oxazoline group-containing polymer.

In a preferred embodiment of the golf ball material of the invention, component (A) is a mixture of:

(a-1) an olefin-α,β-unsaturated carboxylic acid copolymer and/or a metal ion neutralization product thereof,

(a-3) a basic metal compound, and

(a-4) a fatty acid metal salt.

In another preferred embodiment of the inventive golf ball material, component (A) is a mixture of:

(a-2) an olefin-α,β-unsaturated carboxylic acid-α,β-unsaturated carboxylic acid ester copolymer and/or a metal ion neutralization product thereof,

(a-3) a basic metal compound, and

(a-4) a fatty acid metal salt.

The golf ball material of the invention may further include (C) from 1 to 30 parts by weight of a fatty acid per 100 parts by weight of component (A).

In the inventive golf ball material, the polymer serving as component (B) is preferably an acrylic polymer or a styrene polymer.

In a second aspect, the invention provides a golf ball which includes a core, an intermediate layer and an outermost layer and has numerous dimples formed on a surface of the outermost layer, wherein the intermediate layer is formed of the golf ball material according to the first aspect of the invention.

In a third aspect, the invention provides a method of producing a golf ball material that includes (A) a resin mixture containing as the base resin an acid copolymer in which from 90 to 100 mol % of the acid groups are neutralized with metal ions, (B) an oxazoline group-containing polymer and (C) a fatty acid, which method includes the steps of:

(1) melt mixing component (B) and (C), thereby reacting some of the oxazoline groups in component (B) with carboxyl groups in component (C); and (2) melt mixing the mixture obtained in Step (1) with component (A), thereby reacting unreacted oxazoline groups in component (B) with carboxyl groups in component (A).

Preferably, in Step (1) of the inventive method of producing a golf ball material, from 1 to 30 parts by weight of the fatty acid serving as component (C) is included per 100 parts by weight of component (A).

In the inventive method, the polymer of component (B) is preferably an acrylic polymer or a styrene polymer.

### ADVANTAGEOUS EFFECTS OF THE INVENTION

The golf ball material of the invention, as well as golf balls made using this material, has a low hardness and a soft feel, and moreover has a high rebound resilience. Hence, this golf ball material is particularly useful when formed as the intermediate layer in golf balls having an intermediate layer disposed between a core and a cover (outermost layer).

### BRIEF DESCRIPTION OF THE DIAGRAMS

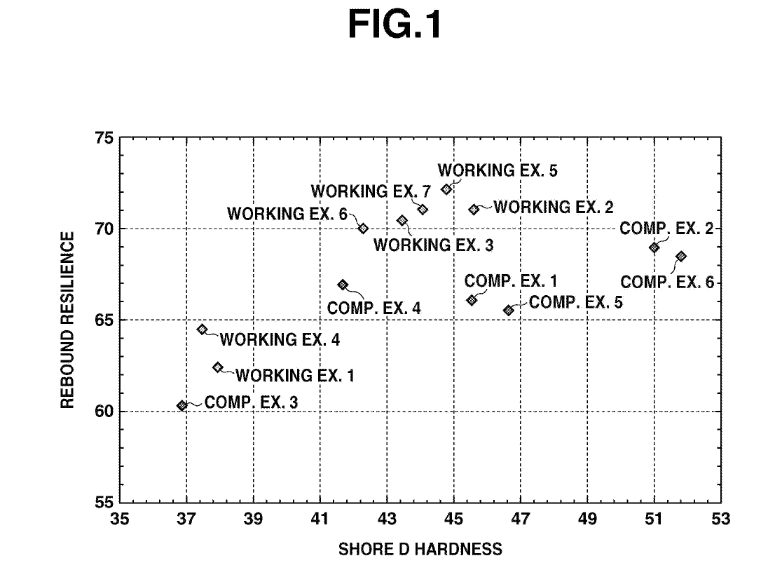

FIG. 1 is a graph showing the relationship between the rebound resilience and Shore D hardness in Working Examples 1 to 7 and Comparative Examples 1 to 6.

### DESCRIPTION OF THE PREFERRED EMBODIMENTS

The objects, features and advantages of the invention will become more apparent from the following detailed description taken in conjunction with the appended diagram.

The golf ball material of the invention includes as essential ingredients:

(A) a resin mixture containing as the base resin an acid copolymer in which from 90 to 100 mol % of the acid groups are neutralized with metal ions, and

(B) an oxazoline group-containing polymer.

The base resin of component (A) is an acid copolymer. The acid groups therein, although not particularly limited, are typically a carboxylic acid, and preferably an unsaturated carboxylic acid. In order to neutralize from 90 to 100 mol % of the acid groups in the base resin of component (A) with metal ions, the use of a resin mixture containing component (a-1) or (a-2) below and also component (a-3) and component (a-4) is preferred:
(a-1) an olefin-α,β-unsaturated carboxylic acid copolymer and/or a metal ion neutralization product thereof,
(a-2) an olefin-α,β-unsaturated carboxylic acid-α,β-unsaturated carboxylic acid ester copolymer and/or a metal ion neutralization product thereof,
(a-3) a basic metal compound, and
(a-4) a fatty acid metal salt.

The olefin in component (a-1) is one in which the number of carbon atoms is generally at least 2 but not more than 8, and preferably not more than 6. Specific examples include ethylene, propylene, butene, pentene, hexene, heptene and octene. Ethylene is especially preferred.

Examples of the unsaturated carboxylic acid include acrylic acid, methacrylic acid, maleic acid and fumaric acid. Acrylic acid and methacrylic acid are especially preferred.

The unsaturated carboxylic acid ester is exemplified by lower alkyl esters of the above carboxylic acids. Illustrative examples include methyl methacrylate, ethyl methacrylate, propyl methacrylate, butyl methacrylate, methyl acrylate, ethyl acrylate, propyl acrylate and butyl acrylate. Butyl acrylate (n-butyl acrylate, i-butyl acrylate) is especially preferred.

The metal ion neutralization product of the above copolymer can be obtained by neutralizing some of the acid groups on the olefin-unsaturated carboxylic acid copolymer or olefin-unsaturated carboxylic acid-unsaturated carboxylic acid ester copolymer with metal ions. Illustrative examples of metal ions which neutralize the acid groups include Na⁺, K⁺, Li⁺, Zn⁺⁺, Cu⁺⁺, Mg⁺⁺, Ca⁺⁺, Co⁺⁺, Ni⁺⁺ and Pb⁺⁺. Preferred use can be made of Na⁺, Li⁺, Zn⁺⁺, Mg⁺⁺ and Ca⁺⁺. Such a neutralization product may be obtained by a known method. For example, a neutralization product can be obtained by using, for the above copolymer, a compound such as a formate, acetate, nitrate, carbonate, bicarbonate, oxide, hydroxide or alkoxide of the above metal ion.

Examples of binary or ternary random copolymers of above components (a-1) and (a-2) include Nucrel® AN4319, AN4214C, N0823, N0903HC, N0908C, AN42012C, N410, N1035, N1050H, AN4229C, N1108C, N11081C, N1110H, N1214, AN4221C, N1525, N1560, N0200H, N035C, AN42115C, AN4213C, AN4228C and AN4233C (all products of DuPont-Mitsui Polychemicals Co., Ltd.).

Examples of metal ion neutralization products of binary or ternary random copolymers of above components (a-1) and (a-2) include Himilan® 1554, 1557, 1601, 1605, 1706, AM7318, AM7311, 1855, 1856 and AM7316 (all products of DuPont-Mitsui Polychemicals Co., Ltd.); Surlyn® 6320, 8320, 9320 and 8120 (all products of E.I. DuPont de Nemours & Co.); and Iotek® 7510 and 7520 (both products of ExxonMobil Chemical).

Because the degree of neutralization by metal ions in commercial products of above components (a-1) and (a-2), i.e., commercial ionomer resins, is generally from 0 to 60 mol %, component (A) of the invention can be obtained by feeding metal ions to this commercial ionomer resin and neutralizing from 90 to 100 mol % of the acid groups on the acid copolymer. Specifically, by using (a-3) a basic metal compound or (a-4) a fatty acid metal salt having the above metal ions and carrying out a known neutralization reaction between this and the base resin (acid groups) of the ionomer, an ionomer in which from 90 to 100 mol % of the acid groups in the acid copolymer are neutralized can be prepared. In this invention, a highly acid-neutralized resin material is used as the resin component in order to increase the resilience.

Examples of the metal ions used in the basic metal compound (a-3) include Li⁺, Na⁺, K⁺, Ca⁺⁺, Mg⁺⁺, Zn⁺⁺, Al⁺⁺, Ni⁺⁺, Fe⁺⁺, Fe⁺⁺, Cu⁺⁺, Mn⁺⁺, Sn⁺⁺, Pb⁺⁺ and Co⁺⁺. The basic metal compound (a-3) is exemplified by basic inorganic fillers containing these metal ions, such as magnesium oxide, magnesium hydroxide, magnesium carbonate, zinc oxide, sodium hydroxide, sodium carbonate, calcium oxide, calcium hydroxide, lithium hydroxide and lithium carbonate. These may be used singly or two or more may be used in combination.

The amount of component (a-3) included depends on the combined amount of un-neutralized acid groups in components (a-1) and (a-2), this being preferably at least 0.5 part by weight, more preferably at least 0.7 part by weight, and even more preferably at least 0.9 part by weight, per 100 parts by weight of components (a-1) and (a-2). The upper limit is preferably not more than 5.0 parts by weight, more preferably not more than 4.8 parts by weight, and even more preferably not more than 4.6 parts by weight. When the component (a-3) content is too low, the acid groups on the acid copolymer may not be adequately neutralized and so the desired resilience may not be obtained.

Examples of the metal ions used in the fatty acid metal salt (a-4) include Li⁺, Ca⁺⁺, Mg⁺⁺, Zn⁺⁺, Mn⁺⁺, Al⁺⁺⁺, Ni⁺⁺, Fe⁺⁺, Fe⁺⁺⁺, Cu⁺⁺, Sn⁺⁺, Pb⁺⁺ and Co⁺⁺. Examples of the fatty acid metal salt (a-4) include magnesium stearate, calcium stearate, zinc stearate, magnesium 12-hydroxystearate, calcium 12-hydroxystearate, zinc 12-hydroxystearate, magnesium arachidate, calcium arachidate, zinc arachidate, magnesium behenate, calcium behenate, zinc behenate, magnesium lignocerate, calcium lignocerate and zinc lignocerate. In particular, preferred use can be made of magnesium stearate, calcium stearate, zinc stearate, magnesium arachidate, calcium arachidate, zinc arachidate, magnesium behenate, calcium behenate, zinc behenate, magnesium lignocerate, calcium lignocerate and zinc lignocerate. These may be used singly or two or more may be used in combination. The fatty acid metal salt (a-4) is an ingredient which has a very small molecular weight compared with the thermoplastic resin of the resin components and is used to suitably adjust the melt viscosity of the mixture, contributing in particular to increased flowability.

The amount of component (a-4) included per 100 parts by weight of components (a-1) and (a-2) may be set to preferably at least 2 parts by weight, more preferably at least 5 parts by weight, and even more preferably at least 10 parts by weight. The upper limit is preferably not more than 70 parts by weight, more preferably not more than 60 parts by weight, and even more preferably not more than 50 parts by weight. When the component (a-4) content is too low, the acid groups on the acid copolymer may not be adequately neutralized and so the desired resilience may not be obtained.

Next, component (B) is described. Component (B) is an oxazoline group-containing polymer. An acrylic polymer or a styrene polymer is especially preferred as the oxazoline group-containing polymer. The oxazoline groups on component (B) react with the carboxyl groups on component (A) to form chemical bonds. Moreover, when the subsequently described component (C) is used, the oxazoline groups on component (B) react with carboxyl groups on component (C) to form chemical bonds, enabling component (C) to be uniformly dispersed in the resin material. This makes it possible for a high rebound resilience to be obtained in spite of the relatively low hardness.

To obtain a golf ball material having both a low hardness and a high rebound resilience, the oxazoline group content in the polymer of component (B) is preferably from 0.1×10⁻³ to 10×10⁻³ mol/g (solids basis), and especially from 0.2×10⁻³ to 8×10⁻³ mol/g (solids basis), per gram of the polymer.

To achieve both a low hardness and a high rebound resilience, it is preferable to set the amount of component (B) included to a ratio, relative to an arbitrary value of 100 for the combined weight of components (A) and (B), in the range of 1 to 35 wt %, and especially 1 to 30 wt %.

A commercial product may be used as the polymer serving as component (B). Examples include the Epocros WS Series and Epocros K-2000 series available from Nippon Shokubai Co., Ltd.

The overall amount of components (A) and (B) is not particularly limited, although it is recommended that this be at least 70 wt %, preferably at least 80 wt %, more preferably at least 90 wt %, and most preferably 100 wt %, of the overall golf ball material. When this content is inadequate, the desired effects of the invention may not be achieved.

In the invention, to lower the resin hardness and impart a soft feel to the ball, it is preferable for the golf ball material of the invention to include a fatty acid as component (C).

From the standpoint of flowability and heat resistance, it is preferable to use a saturated fatty acid or unsaturated fatty acid of at least 14 carbon atoms as the fatty acid (C). Specific examples of the fatty acid of this component (C) include stearic acid, 12-hydroxystearic acid, behenic acid, oleic acid, linoleic acid, linolenic acid, arachidic acid and lignoceric acid. The use of stearic acid, arachidic acid, behenic acid or lignoceric acid is especially preferred.

The amount of this fatty acid included depends on the total amount of oxazoline groups on the component (B) that is added together, but is preferably from 1 to 30 parts by weight, and more preferably from 3 to 15 parts by weight, per 100 parts by weight of component (A).

Where necessary, the golf ball material of this invention may also suitably include optional additives. Various additives may be selected depending on the intended use of the golf ball material. For example, pigments, dispersants, antioxidants, ultraviolet absorbers and light stabilizers may be added. When such additives are included, the amount in which these are added per 100 parts by weight of components (A) and (B) combined is generally at least 0.1 part by weight, and preferably at least 0.5 part by weight, but generally not more than 10 parts by weight, and preferably not more than 4 parts by weight.

The golf ball material of the invention can be obtained by mixing together the above ingredients using, for example, an internal mixer such as a kneading-type twin-screw extruder, a Banbury mixer or a kneader. The extruder used in production is preferably a twin-screw extruder.

The mixing method is not particularly limited, although it is preferable to first obtain a resin composition of component (B) and component (C) that have been thoroughly melt mixed, and to subsequently add and work therein component (A). That is, by first melt mixing components (B) and (C), some of the oxazoline groups in component (B) are made to react with carboxyl groups in component (C). The remaining unreacted oxazoline groups in component (B) are then reacted with carboxyl groups in component (A), giving a golf ball material composed of a mixture of components (A) to (C). Through these reactions, component (C) disperses uniformly in the resin mixture of component (A).

The relationship between the amount of component (B) included and the amount of component (C) included is preferably such that, letting the amount of component (B) for which oxazoline groups in component (B) and carboxyl groups (COOH) in component (C) are equimolar have a weight of 100, the included amount of component (B) is at least 5% thereof. That is, the amount of component (B) included is preferably adjusted so as to satisfy the following relationship:

component (B) included (g)≥[component (C) included (g)×molar amount of COOH groups (mmol/g) in component (C)]/[molar amount of oxazoline groups (mmol/g) in component (B)]×0.05.

When component (B) is utilized in a form that involves the use of a solvent, the concentration of component (B) must be taken into account.

To ensure a flowability that is particularly suitable for injection molding and to improve the moldability, the golf ball material of the invention preferably has a melt flow rate (MFR) in a specific range. The MFR is generally at least 0.1 g/10 min, and preferably at least 0.5 g/10 min. The upper limit is generally not more than 50 g/10 min, and preferably not more than 30 g/10 min. At MFR values that are larger or smaller than this range, the processability may markedly decline. As used herein, the melt flow rate is a value measured in general accordance with ASTM D1238 at a test temperature of 190° C. and under a test load of 21.18 N (2.16 kgf).

The golf ball material of the invention has a Shore D hardness which is preferably at least 30, and more preferably at least 33, but preferably not more than 55, and more preferably not more than 53. When the Shore D hardness is too high, the golf ball may lack a soft feel at impact. On the other hand, when the Shore D hardness value is too low, the ball rebound may decrease. The Shore D hardness here is the material hardness obtained for the resin material when molded into a sheet using a molding press.

The golf ball material of the invention has a rebound resilience, as measured according to JIS-K 6255 (2013), of preferably at least 60%, and more preferably at least 62%. This rebound resilience is the rebound resilience of a molding obtained by molding the resin material into a sheet using a molding press.

The golf ball of the invention is a golf ball in which a molding formed using the golf ball material of the invention serves as a ball component. The molding obtained from the golf ball material may be used as either part or all of the golf ball. Examples of places where the molding may be used include the cover in a wound golf ball where the cover consists of a single layer or has a multilayer construction of two or more layers, a one-piece golf ball, and the solid core, intermediate layer or cover in a multi-piece golf ball such as a two-piece solid golf ball or three-piece solid golf ball. The type of golf ball is not particularly limited, so long as the golf ball is one in which a molding of the inventive golf ball material serves as a ball component.

It is preferable in particular for the golf ball material of the invention to be suitably used as the intermediate layer material in a multi-piece solid golf ball which has a core of one or more layer, one or more intermediate layer encasing the core, and a cover of one or more layer encasing the intermediate layer. The golf ball material of the invention has an excellent resilience, but is sometimes inferior in terms of durability to ionomers which have an ordinary degree of neutralization (about 50%) and thus may have a poor durability when used as the outermost layer. Hence, the inventive golf ball material is preferably used as the intermediate layer. It is preferable to use an ionomer having an ordinary degree of neutralization (about 50%) in the outermost layer.

### EXAMPLES

The following Working Examples and Comparative Examples are provided to illustrate the invention, and are not intended to limit the scope thereof.

### Working Examples 1 to 7, Comparative Examples 1 to 6

Resin Mixtures No. 1 to No. 4 were prepared as component (A) by formulation as shown in Table 1 below.

TABLE 1

| | Resin material (pbw) | | | |
|---|---|---|---|---|
| | No. 1 | No. 2 | No. 3 | No. 4 |
| (a-2) Base resin (1) | 50 | 50 | 50 | 50 |
| (a-2) Base resin (2) | 50 | 50 | 50 | 50 |
| (a-3) Basic metal compound | 1.51 | 1.51 | 1.12 | 1.05 |
| (a-4) Fatty acid metal salt | 13 | 23 | 30 | 40 |
| Degree of neutralization (mol %) | 99.5 | 99.5 | 90 | 90 |
| Total weight (g) | 114.51 | 124.51 | 131.12 | 141.05 |

Trade names for the materials in the table are as follows.
(a-2) Base resin (1): Nucrel® AN4319, a terpolymer (MAA) available from DuPont-Mitsui Polychemicals Co., Ltd.
(a-2) Base resin (2): Surlyn® 9320, an ionomer resin (neutralizing metal, Zn) available from E.I. DuPont de Nemours & Co.
(a-3) Basic metal compound: “Kyowamag MF-150” from Kyowa Chemical Industry Co., Ltd.
(a-4) Fatty acid metal salt: “Magnesium Stearate G” from NOF Corporation

Next, the resin mixtures (A) obtained above, an oxazoline-containing polymer (the styrene/acrylic polymer Epocros K-2010E from Nippon Shokubai Co., Ltd.) as component (B) and oleic acid (the oleic acid NAA35 from NOF Corporation) as component (C) were used in the formulations shown in Table 2.

Steps (1) and (2) below were carried out during preparation of the golf ball material.

### Step (1)

Components (B) and (C) in the specific amounts shown in Table 2 were mixed together in a beaker heated and set to 100° C., thereby giving a liquid or slurry-like mixture in which some of the oxazoline groups in component (B) have reacted with carboxyl groups in component (C).

### Step (2)

Component (A) and the mixture obtained in Step (1) were melt-mixed in a roller mixer set to a temperature of 160° C., kneaded for 8 minutes at a blade rotational speed of 50 rpm, and the resulting blend was collected.

The hardness and rebound resilience of the golf ball material were determined by the following methods.

### Hardness of Resin Material

The resin material was molded with a molding press into 2 mm thick sheets which were then stacked to a thickness of at least 6 mm and held isothermally at 23±1° C., following which the Shore D hardness was measured in accordance with ASTM D2240 using a type D durometer.

### Rebound Resilience

The resin material was molded with a molding press into 2 mm thick sheets which were then stacked to a thickness of 4 mm and held isothermally at 23±1° C., following which the rebound resilience was measured based on JIS-K 6255 (2013). Specifically, the rebound resilience was measured after adjusting the falling angle mentioned in JIS-K6255 to 30 degrees.

TABLE 2

| Formulation | | Working Example | | | | | | | Comparative Example | | | | | |
|---|---|---|---|---|---|---|---|---|---|---|---|---|---|---|
| (pbw) | | 1 | 2 | 3 | 4 | 5 | 6 | 7 | 1 | 2 | 3 | 4 | 5 | 6 |
| Composition | (A) | No. 1 | No. 1 | No. 1 | No. 1 | No. 1 | No. 1 | No. 1 | No. 1 | No. 2 | No. 1 | No. 1 | No. 3 | No. 4 |
| | | 100 | 100 | 100 | 100 | 100 | 100 | 100 | 100 | 100 | 100 | 100 | 100 | 100 |
| | (B) | 3.2 | 2.9 | 3.0 | 6.3 | 5.7 | 6.0 | 5.9 | — | — | — | — | — | — |
| | (C) | 11.1 | — | 5.3 | 11.1 | — | 5.3 | 1.0 | — | — | 11.1 | 5.3 | — | — |

| | | | | | | | | | | | | | |
|---|---|---|---|---|---|---|---|---|---|---|---|---|---|
| Hardness (Shore D) | 38 | 46 | 43 | 37 | 45 | 42 | 44 | 46 | 51 | 37 | 42 | 47 | 52 |
| Rebound resilience (%) | 63 | 71 | 70 | 65 | 72 | 70 | 71 | 66 | 69 | 60 | 67 | 66 | 69 |

The graph in FIG. 1 shows the relationship between the Shore D hardness and the rebound resilience obtained in the respective Examples. The following is apparent from this graph.

Working Examples 2 and 5 in which component (B) was added had substantially the same hardness and a higher rebound resilience than Comparative Example 1 in which component (B) was not added.

Also, in contrasting Working Example 6 with Comparative Example 4 and Working Example 4 with Comparative Example 3, each of these Working Examples in which component (B) was added had a higher rebound resilience than the Comparative Examples in which component (B) was not added, and yet remained soft.

Japanese Patent Application No. 2017-239477 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball material comprising:
(A) a resin mixture containing as a base resin an acid copolymer in which from 90 to 100 mol % of the acid groups are neutralized with metal ions, and
(B) an oxazoline group-containing polymer.

2. The golf ball material of claim 1, wherein component (A) is a mixture of:
(a-1) an olefin-α,β-unsaturated carboxylic acid copolymer or a metal ion neutralization product thereof or both,
(a-3) a basic metal compound, and
(a-4) a fatty acid metal salt.

3. The golf ball material of claim 1, wherein component (A) is a mixture of:
(a-2) an olefin-α,β-unsaturated carboxylic acid-α,β-unsaturated carboxylic acid ester copolymer or a metal ion neutralization product thereof or both,
(a-3) a basic metal compound, and
(a-4) a fatty acid metal salt.

4. The golf ball material of claim 1, further comprising:
(C) from 1 to 30 parts by weight of a fatty acid per 100 parts by weight of component (A).

5. The golf ball material of claim 1, wherein the polymer serving as component (B) is an acrylic polymer or a styrene polymer.

6. A golf ball comprising a core, an intermediate layer and an outermost layer and having numerous dimples formed on a surface of the outermost layer, wherein the intermediate layer is formed of the golf ball material of claim 1.

7. A method of producing a golf ball material comprising
(A) a resin mixture containing as a base resin an acid copolymer in which from 90 to 100 mol % of the acid groups are neutralized with metal ions,
(B) an oxazoline group-containing polymer, and
(C) a fatty acid, which method comprises the steps of:
(1) melt mixing component (B) and (C), thereby reacting some of the oxazoline groups in component (B) with carboxyl groups in component (C); and
(2) melt mixing the mixture obtained in Step (1) with component (A), thereby reacting unreacted oxazoline groups in component (B) with carboxyl groups in component (A).

8. The method of claim 7 which, in Step (1), includes from 1 to 30 parts by weight of the fatty acid serving as component (C) per 100 parts by weight of component (A).

9. The method of claim 7, wherein the polymer of component (B) is an acrylic polymer or a styrene polymer.
